(19) United States
(12) Patent Application Publication
(10) Pub. No.: US 2026/0008237 A1
(43) Pub. Date: Jan. 8, 2026

(54) FENESTRATION UNIT WITH INDUCTION WELDED JOINT AND MANUFACTURING SYSTEM AND MANUFACTURING METHOD FOR THE SAME

(71) Applicant: JELD-WEN, Inc., Charlotte, NC (US)

(72) Inventors: Kyle David Hales, Klamath Falls, OR (US); Kirk A. Brunssen, Orchard Lake, MI (US); Scott R. Tedrick, Davison, MI (US); Joseph A. Riley, Clinton Township, MI (US)

(73) Assignee: JELD-WEN, Inc., Charlotte, NC (US)

(21) Appl. No.: 19/257,347

(22) Filed: Jul. 1, 2025

Related U.S. Application Data
(60) Provisional application No. 63/666,765, filed on Jul. 2, 2024.

(51) Int. Cl. B29C 65/36; B29C 65/72; B29C 65/78; B29K 627/06; B29L 31/00

(52) U.S. Cl. CPC B29C 65/3604; B29C 65/72; B29C 65/7802; B29K 2627/06; B29L 2031/005

(57) ABSTRACT

A method of manufacturing includes providing a first and second member of a fenestration unit, wherein the first and second members are formed at least partly from a polymeric material. The method further includes providing a weld interface member having a susceptor portion and a cover portion, and at least the susceptor portion includes a susceptor material that is susceptible to induction heating. The cover portion includes a cover material. The method further includes positioning the weld interface member against the first member and the second member at a joint arrangement. The method additionally includes heating, by induction heating, the susceptor material to melt the susceptor portion and the cover portion. Also, the method includes re-solidifying the susceptor portion and the cover portion to attach the first member and the second member, including covering the susceptor material at the joint arrangement with a resolidified portion of the cover material.

### CROSS REFERENCE TO RELATED APPLICATION

The present application claims priority to U.S. Provisional Patent Application Ser. No. 63/666,765, filed Jul. 2, 2024, the entire disclosure of which is incorporated by reference.

### TECHNICAL FIELD

The field of this disclosure relates generally to fenestration units and, more particularly, to a fenestration unit with at least one induction welded joint and a manufacturing system and a manufacturing method for the same.

### BACKGROUND

A large variety of fenestration units, such as doors, windows, skylights, sidelites, etc. have been proposed. Preferably, the fenestration unit is strong and secure, provides robust weather resistance, is ergonomically sound, and/or provides other beneficial characteristics to a building or other structure. Furthermore, the fenestration unit may preferably be manufactured with high efficiency.

However, manufacturing a fenestration unit may be difficult, expensive, time consuming, and/or otherwise disadvantageous. For example, some fenestration units are assembled using a plurality of fasteners, which may increase manufacturing time and expense. It may be difficult to make joints that are aesthetically pleasing. Moreover, the use of adhesives, sealants, and the like may present significant manufacturing challenges. The fenestration unit also may include particular part geometry, material constraints, and other characteristics that contribute to manufacturing inefficiencies.

Thus, there remains a need for a fenestration unit, which may be manufactured more efficiently without compromising the fenestration strength, security, weather resistance, ergonomic operability, etc. Furthermore, there remains a need for manufacturing systems and methods for manufacturing this type of fenestration unit. Additional aspects and benefits will be apparent from the following detailed description of example embodiments, which proceeds with reference to the accompanying drawings.

### SUMMARY

According to various embodiments, a method of manufacturing a fenestration unit is disclosed that includes providing a first member of the fenestration unit, wherein the first member is formed at least partly from a polymeric material. The method includes providing a second member of the fenestration unit, wherein the second member is formed at least partly from a polymeric material. The method further includes providing a weld interface member having a susceptor portion and a cover portion, and at least the susceptor portion includes a susceptor material that is susceptible to induction heating. The cover portion includes a cover material. The method further includes positioning the weld interface member against the first member and the second member at a joint arrangement. The method additionally includes heating, by induction heating, the susceptor material to melt the susceptor portion and the cover portion. Also, the method includes re-solidifying the susceptor portion and the cover portion to attach the first member and the second member, including covering the susceptor material at the joint arrangement with a resolidified portion of the cover material.

According to additional embodiments, a weld interface member for joining a first member and a second member of a fenestration unit at a joint arrangement is disclosed. The first member and the second member are formed at least partly from a polymeric material. The weld interface member includes a susceptor portion, a cover portion, and at least the susceptor portion including a susceptor material that is susceptible to induction heating. The cover portion includes a cover material. The susceptor material is susceptible to induction heating for melting the susceptor portion and the cover portion. The cover material is configured to re-solidify at a resolidified portion that covers the susceptor material at the joint arrangement.

Moreover, according to additional embodiments, a manufacturing system for manufacturing a fenestration unit is disclosed. The system includes an induction welding device and a handling system for handling a first member of the fenestration unit, a second member of the fenestration unit, and a weld interface member. The first member is formed at least partly from a polymeric material. The second member is formed at least partly from a polymeric material, and the weld interface member has a susceptor portion and a cover portion. At least the susceptor portion includes a susceptor material that is susceptible to induction heating. The cover portion includes a cover material, and the welding interface member is positioned against the first member and the second member at a joint arrangement. The induction welding device is configured to induction heat the susceptor material to melt the susceptor portion and the cover portion before the susceptor portion and cover portion are re-solidified to attach the first member and the second member. The susceptor material is covered at the joint arrangement with a resolidified portion of the cover material.

### BRIEF DESCRIPTION OF DRAWINGS

The exemplary embodiments will hereinafter be described in conjunction with the following drawing figures, wherein like numerals denote like elements, and wherein:

FIG. 1 is a schematic perspective view of a fenestration unit according to various embodiments of the present disclosure;

FIG. 2 is an exploded perspective view of a joint arrangement of the fenestration unit of FIG. 1 from a first perspective;

FIG. 3 is an exploded perspective view of the joint arrangement of the fenestration unit of FIG. 1 from a second perspective;

FIG. 4 is a perspective view of the joint arrangement of FIGS. 2 and 3;

FIG. 5 is a first perspective view of a weld interface member of the joint arrangement of FIGS. 2-4;

FIG. 6 is a second perspective view of the weld interface member of the joint arrangement of FIGS. 2-4;

FIG. 7 is a schematic view of a manufacturing system for manufacturing the fenestration unit of FIGS. 1-6 according to example embodiments;

FIG. 8 is a front view of the joint arrangement of the fenestration unit of FIG. 1 according to additional embodiments of the present disclosure;

FIG. 9 is a perspective view of the joint arrangement of the fenestration unit of FIG. 1 according to additional embodiments of the present disclosure;

FIG. 10 is a perspective view of the joint arrangement of the fenestration unit of FIG. 1 according to additional example embodiments; and

FIG. 11 is a perspective view of a weld interface member of the joint arrangement of FIG. 10 according to example embodiments of the present disclosure.

### DETAILED DESCRIPTION

The following Detailed Description is exemplary in nature and is not intended to limit the various embodiments or the application and uses thereof. Furthermore, there is no intention to be bound by any theory presented in the preceding background or the following detailed description.

In some embodiments, the present disclosure relates to a fenestration unit that is formed, at least partly, from a polymeric material. For example, the fenestration unit of the present disclosure may include one or more frame members or other parts that are made of or include a polymeric material. The frame member(s) may be formed of vinyl in some embodiments. In additional embodiments, the frame member(s) may be formed of a composite material in which polymeric material is the matrix material thereof.

Furthermore, the fenestration unit may be manufactured, at least partly, via an induction welding process. As such, two or more parts may be joined via the induction welding process.

In some embodiments, a weld interface member (i.e., a welding key, a welding insert, implant, gasket, etc.) may be provided between a first part and a second part. The weld interface member may comprise a first material and a second material. The first material (e.g., a thermoplastic) may be weldable, compatible, etc. with the material of the first part and the second part. The second material (e.g., ferromagnetic particles, fibers, mesh, or other material) may be susceptible to induction heating. These “susceptors” may be made from iron oxide, nickel, stainless steel, or other material.

An induction coil may be used to heat the electromagnetically susceptible second material of the weld interface member. The heat may melt the first material as well as a portion of the first part and the second part, e.g., creating a melt zone of molten material. The molten material may be subsequently cooled, cured, etc. resulting in an induction weldment that integrally bonds the first part to the second part at the joint arrangement.

The weld interface member may be shaped or otherwise tailored for a particular joint of a fenestration unit. In some embodiments, the weld interface member may be received within the first part and/or the second part before the induction welding process. Furthermore, the weld interface member may include surfaces, shaped features, etc. for facilitating the induction welding process. The size, shape, construction, etc. of the weld interface member may be predetermined and selected according to the characteristics, features, etc. of the first and second members at the joint arrangement. Accordingly, the weld interface member may fit neatly within the joint arrangement, the welded joint may be formed evenly and with aesthetically pleasing features, and the joint may be strong and robust.

A manufacturing system may be employed for induction welding of one or more areas of the fenestration unit. For example, the manufacturing system may include an induction coil configured to provide the electromagnetic field. An induction generator may be included for powering the induction coil. Furthermore, the manufacturing system may include one or more fixtures for holding the parts during the welding process. Also, the system may include an actuator, press, etc. for applying pressure to the joint.

The induction coil may convert the high frequency current from the induction generator into an alternating magnetic field. In some embodiments, the induction coil may be configured and tailored for a particular joint of the fenestration unit such that the joint is effectively exposed to the field and the induction weldment is formed efficiently. The applied electromagnetic field may heat the ferromagnetic material within the joint, and the heat may conduct to and melt the surrounding polymeric materials. This may create a melt layer within the joint arrangement, and the molten polymer may flow to fill gaps, spaces, etc. within the joint arrangement. At a predetermined time, the induction coil may be de-energized, and the joint may be cooled under pressure.

Various parameters may be predetermined and selected to increase manufacturing efficiency. For example, power output of the induction generator may be adjusted according to the respective joint and the distance between the coil and the insert member within the joint. Furthermore, pressure applied to the joint may be predetermined and selected to promote even distribution of the molten polymer in the joint. Additionally, welding time and/or cooling time may be selectively adjusted to increase manufacturing efficiency.

Accordingly, the fenestration unit may be manufactured efficiently. Also, direct contact between the induction coil and the joint is unnecessary; which may increase manufacturing convenience and efficiency.

The weldment, once formed, may also define a seal, a fluid barrier, plug, etc. between the first member and the second member. Furthermore, the weldment may be used as a seal, barrier, plug, etc. and use of other undesirable sealants may be avoided.

More specific embodiments of the present disclosure will now be discussed.

In some embodiments, electromagnetic (EMA)/Induction welding processes are used to form one or more joints of a fenestration unit. Polymeric parts of the fenestration unit may be joined as such. Systems and methods of the present disclosure related to induction welding may be utilized to weld parts made from numerous materials, such as thermoplastic polymers and polymeric composites. In some embodiments, parts made according to the present disclosure may be made from thermoset polymeric material. In further embodiments, the polymer components can be composed of a homogenous rigid polyvinyl chloride or chlorinated polyvinyl chloride material, a combination of chlorinated and non-chlorinated polyvinyl chloride materials, or in the case of polymer composites, incorporate filler or reinforcement materials suspended in a combination of rigid polyvinyl chloride and chlorinated polyvinyl chloride matrix materials. The material composition of these components may be selected and/or altered to augment the physical and mechanical properties of the components for specific applications. The polymer fenestration units may be assembled using a combination of extruded polymer components which are arranged and joined at intersections to form various window and door configurations.

Tailored welding keys (Polymer Fenestration Unit Induction Welding Keys or PFUIWK's) composed of ferromagnetic-particle and polymer composite (FPPC) materials may be cut, molded, extruded, or formed into specific shapes that correspond to a particular joint. The PFUIWK may be used to fuse and/or hermetically seal any/all vinyl and composite (polymer) fenestration unit frame, sash, panel, and accessory assembly joints. This may produce, strong, aesthetically pleasing, near-seamless weld seams, at one or more polymer fenestration unit joint locations-including joint locations that are difficult to form using other fusion welding processes (such as incontiguous regions of existing joints, fixed interlock-to-frame, mullion-to-frame, accessory-to-frame, or glazing bead to frame joint locations.

A large variety of PFUIWK embodiments fall within the scope of the present disclosure. The PFUIWK embodiments may be designed for use producing a continuous weld seam and/or hermetic seal at a specific location between a minimum of two adjoining vinyl or composite fenestration unit assembly components (including frame, sash, or accessory components).

The PFUIWK embodiments may contain, at minimum, a single volumetric region of ferromagnetic-particle and polymer composite material that is chemically compatible with the polymer composition of adjoining fenestration unit components.

In some embodiments, the PFUIWK may be designed to hold FPPC material in compression directly against the adjoining fenestration unit assembly joint surfaces precisely where the weld seam and or seal is to be produced. This PFUIWK embodiment may include incorporated channels sufficient to contain the majority of the total FPPC material when the weld is complete, and the material has spread across the joint cavity. However, sufficient interference between the PFUIWK, FPPC material, and adjoining surfaces may be incorporated into the PFUIWK design to produce consistent joint fill.

In additional PFUIWK embodiments, the PFUIWK is designed to hold FPPC material in compression directly against the adjoining fenestration unit assembly joint surfaces precisely where the weld seam and or seal is to be produced. However, no cavity is present in the PFUIWK design to contain molten FPPC material during the EMA/Induction welding process. In this PFUIWK embodiment, external pressure is held against exposed FPPC surfaces by an external source to contain molten FPPC material until the FPPC material has fused to the adjacent components, cooled, and hardened.

In some embodiments, the PFUIWK may include a contoured FPPC shape approximating the shape of the adjoining component contact area to ensure all adjoining surfaces are evenly heated, and subsequently wet out, by FPPC material during the EMA/Induction welding process. Any PFUIWK or FPPC material that may be, or is, necessarily visible post EMA/Induction welding process (due to joint design requirements) will closely align with visible component surfaces to produce a thin, clean, aesthetically pleasing joint seam.

The PFUIWK may be colored similarly to the adjoining material to produce aesthetically pleasing weld seams and/or seals where the PFUIWK or FPPC material may be, or is, necessarily visible post EMA/induction welding process (due to joint design requirements).

During the EMA/induction welding process, FPPC material is heated by electromagnetic field induction by a conductive coil positioned closely to the joint. Heat is transferred from the PFUIWK to the material immediately adjacent to it via conduction. The FPPC material on/in the PFUIWK liquifies and spreads out across the joint seam as the temperature of the base material is brought high enough to produce fusion between the molten FPPC material, the PFUIWK body, and the adjoining component surfaces. Once the fusion temperature has been achieved, the electromagnetic field is removed, and the joint is allowed to cool. This entire process happens very quickly, preventing thermal saturation or deformation of the visible base component material surfaces immediately adjacent the joint.

The joint-specific PFUIWK embodiments and the EMA/induction welding process may be used as a standalone (primary) joint assembly process, or in conjunction with other joint assembly processes (secondary joint assembly process) to produce strong, aesthetically pleasing, near seamless, fenestration unit assembly joints on new and existing products.

### Example—Primary Joint Assembly of a Simple Vinyl or Composite Fenestration Frame Weldment by EMA/Induction Welding Process Utilizing Specific PFUIWK's

First, all frame components are loaded into an automated frame clamp. Second, the PFUIWK's are inserted between adjoining frame components and the components are drawn together and loosely seated against the PFUIWK's. Third, a clamping force is applied to the frame to firmly seat the frame components against the PFUIWK's. Fourth, an induction field is applied to the FPPC material in each PFUIWK while constant clamping force maintains firm purchase between the PFUIWK and adjacent frame components. Under compression in the presence of an induction field, the FPPC material in the PFUIWK's melts and redistributes evenly throughout the weld cavities between the PFUIWK's and adjacent component surfaces. While the FPPC material is redistributed within the weld cavities, heat is transferred to the adjacent component surfaces via conduction. When the fusion temperature is reached at the frame component and PFUIWK bonding surfaces, and the weld cavity is completely wet out, the induction field is removed, and the joints are allowed to cool in the frame clamp under constant pressure. Finally, when the joints have cooled sufficiently to prevent distortion, the frame weldment is removed from the frame clamp and sent down the line for final assembly.

### Example—Secondary Joint Assembly Process on a Simple Vinyl or Composite Fenestration Frame Weldment by EMA/Induction Welding Process Utilizing Specific PFUIWK's

First, a fenestration frame is assembled using an automated (heated tool) frame welder. The weld seams are cleaned of excess weld material using an automated cleaner and the fenestration frame weldment is pulled for secondary processing to attach a sill riser extension. Second, the frame weldment is clamped in place at the induction welding station. Third, PFUIWK's are inserted between adjoining frame and sill riser extension components. Fourth, the riser extension is clamped into position to compress the PFUIWK between the frame and sill riser extension and to support and contain the FPPC material at the sill riser extension ends when it is heated to a molten state. Fifth, a coil is positioned over the weld seam and an electromagnetic field is produced to heat the FPPC material within the PFUIWK. As the FPPC material is heated, it transfers heat to the adjacent component surfaces via conduction. When the FPPC material approaches fusion temperature, it begins to liquify and flow throughout the weld cavity between the PFUIWK and adjacent component surfaces. The sill riser extension settles into its final position under clamping force, and the weld cavity is filled with FPPC material. Sixth, the electromagnetic field is removed, and the joint is allowed to cool in the clamp under pressure. Finally, when the joints have cooled sufficiently to prevent distortion, the frame weldment is removed from the frame clamp and sent down the line for final assembly.

### Example—Joint Repair Process on a Vinyl or Composite Fenestration Frame Weldment by EMA/Induction Welding Process Utilizing Specific PFUIWK's Conducted Off Site

A Tilt Single hung unit assembled using traditional methods is flagged for sill riser joint repair off site. The sill riser extension is damaged and requires replacement. First, the technician sent to make the repair removes the existing sill riser and all sealants present on the frame from the previous installation. Second, a new sill riser is installed with a flexible PFUIWK's inserted between the adjoining frame and the new sill riser components. A spreader bar is used to seat the sill riser and fully compress the PFUIWK between the frame and sill riser. A specialized PTFE block is positioned over the sill riser end and held firmly against the frame jamb. The block will support and contain the FPPC material at the sill riser end when it is heated to a molten state. Next, a coil contained within the PTFE block is used to produce an electromagnetic field to heat the FPPC material within the PFUIWK. As the FPPC material is heated, it transfers heat to the adjacent component surfaces via conduction. When the FPPC material approaches fusion temperature, it begins to liquify and flow throughout the weld cavity between the PFUIWK and adjacent component surfaces. Next, the electromagnetic field is removed, and the joint is allowed to cool with the block in position. When the region has cooled sufficiently to prevent distortion, the block is repositioned to a new position on the sill riser slightly overlapping the previous position and the process is repeated until the joint is welded completely.

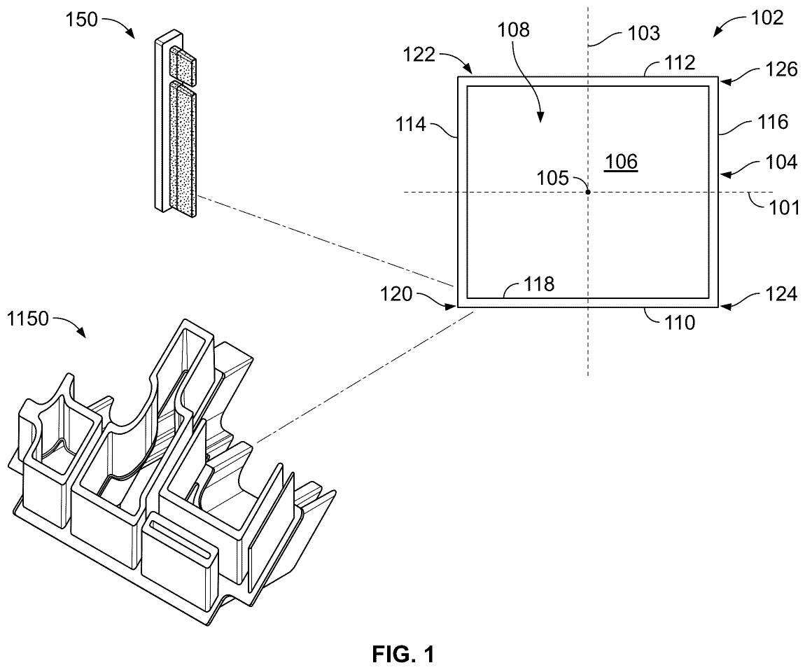

Referring now to FIG. 1, a fenestration unit 102 is illustrated schematically. The fenestration unit 102 may be a window unit in some embodiments. In additional embodiments, the fenestration unit 102 may be a door, a patio door, a skylite, etc. As shown, the fenestration unit 102 may be rectangular; however, the fenestration unit 102 may have another shape. The fenestration unit 102 may have more or less than four peripheral sides. Also, at least part of the periphery of the fenestration unit 102 may be curved, arcuate, etc.

The fenestration unit 102 may define a Cartesian coordinate system with a first axis 101, a second axis 103, and a third axis 105. The first axis 101 may be a horizontal axis and may extend between a left side and right side of the fenestration unit 102. The second axis 103 may be a vertical axis that extends between the top side and bottom side of the fenestration unit 102. The third axis 105 may be a horizontal axis that extends between an interior side and an exterior side of the fenestration unit 102.

The fenestration unit 102 is shown generically in FIG. 1, but those having ordinary skill in the art will understand that the fenestration unit 102 may have a plurality of different configurations without departing from the scope of the present disclosure. The fenestration unit 102 may include a fenestration frame 104 and a glazing unit 106 supported therein. In some embodiments, the glazing unit 106 may be included in a sash 108, which is supported within the frame 104. The sash 108 may be moveable within the frame 104 between a closed position and an open position. The sash 108 may be supported for sliding/gliding movement within the frame 104, supported for tilting/pivoting movement relative to the frame 104, or otherwise supported within the frame 104. Furthermore, it will be appreciated that the fenestration unit 102 of the present disclosure may comprise a door, a patio door system, a sidelite, a skylite, or other fenestration unit 102.

The frame 104 may include a plurality of elongate, lineal members, including a sill member 110, a header member 112, a first jamb 114, and a second jamb 116. The sill member 110 and header member 112 may extend longitudinally along the first axis 101 and may be spaced apart along the second axis 103. The first and second jambs 114, 116 may extend longitudinally along the second axis 103 and may be spaced apart along the first axis 101. The first jamb 114 may be fixed to the sill member 110 at a first corner joint arrangement 120 and to the header member 112 at a second corner joint arrangement 122. The second jamb 116 may be fixed to the sill member 110 at a third corner joint arrangement 124 and to the header member 112 at a fourth corner joint arrangement 126.

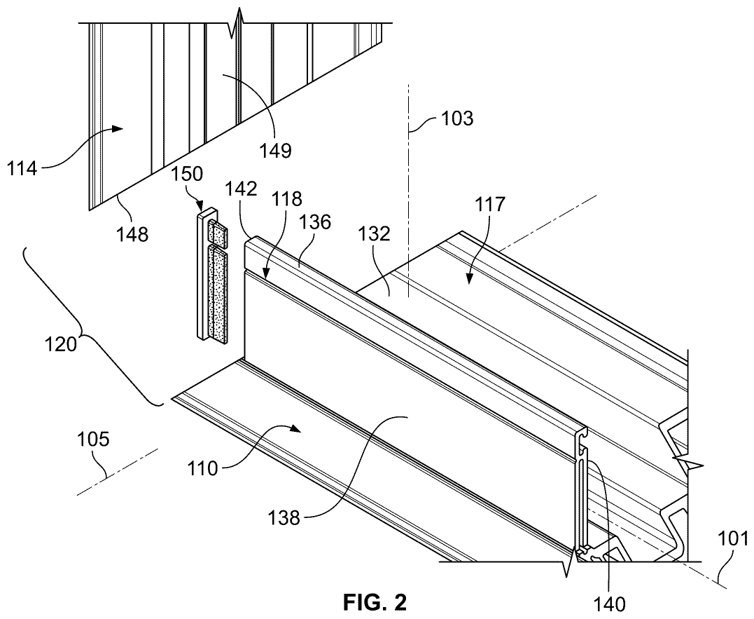

Additional features of the first corner joint arrangement 120 is illustrated according to example embodiments in FIGS. 2, 3, and 4. It will be appreciated that features of the first corner joint arrangement 120 may be included at the second corner joint arrangement 122, the third corner joint arrangement 124, and/or the fourth corner joint arrangement 126.

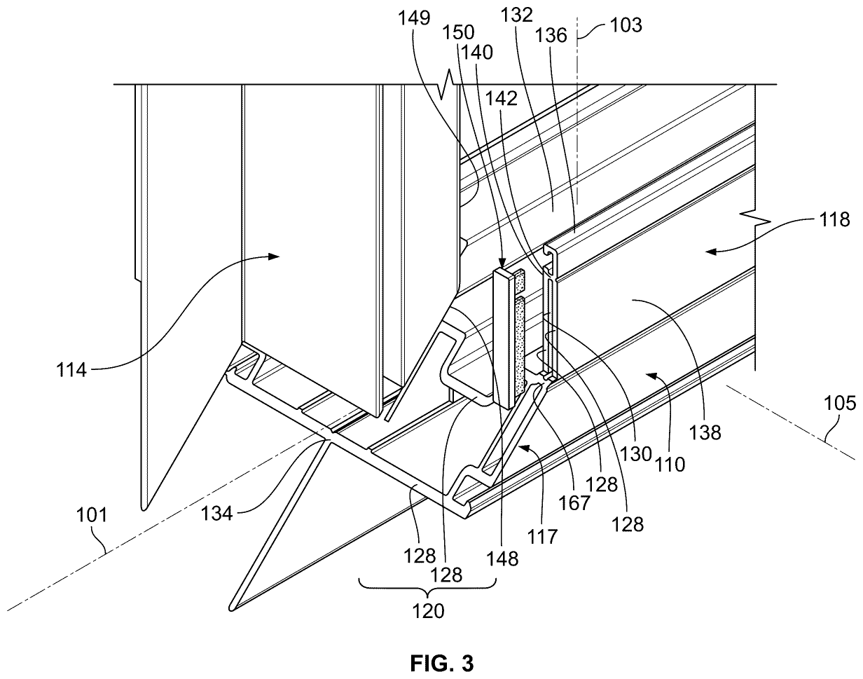

In some embodiments, the sill member 110 may be unitary and monolithic member that includes a plurality of walls 128 (FIG. 3) that are interconnected. The walls 128 may be spaced apart to define a plurality of cavities or channels 130 (FIG. 3) extending longitudinally along the first axis 101. In some embodiments, the sill member 110 may be a longitudinally straight lineal member extending substantially parallel to the axis 101. In some embodiments, the sill member 110 may be an extrudate (i.e., a part formed via an extrusion process). The sill member 110 may be formed of, composed of, consist of, and/or include a polymeric material, such as vinyl.

The sill member 110 may define a sill base 117. The sill base 117 may be hollow and flattened such that the height of the sill base 117 (measured along the second axis 103) is less than the width of the sill base 117 (measured along the third axis 105). The sill base 117 may also include an upper face 132, which faces substantially along the second axis 103 toward the sash 108, the glazing unit 106, and the header member 112 (FIG. 1). The upper face 132 may define a track, groove, projection, channel, recess, glass stop, or other feature for supporting the sash 108 and/or the glazing unit 106. Also, the sill base 117 may include a terminal end 134, (see FIG. 3). The terminal end 134 may be collectively defined by an end or edge of the walls 128 and, thus, the terminal end 134 may be open to the channels 130 defined between the walls 128. In some embodiments, the terminal end 134 may be disposed at a non-zero angle relative to the second axis 103. For example, the terminal end 134 may be disposed at approximately a forty-five degree (45°) angle for joining the sill base 117 to the first jamb 114 at the first corner joint arrangement 120.

The sill member 110 may also include a sill riser 118. The sill riser 118 may be integrally attached to the sill base 117 and may project upward along the second axis 103 from the sill base 117. The sill riser 118 may be disposed to one side of the sill base 117 along the third axis 105. The sill riser 118 may be substantially rectangular in a cross-section taken normal to the first axis 101 (see FIG. 3). The sill riser 118 may have a height measured along the second axis 103 from the sill base 117 to a top terminal edge 136. The sill riser 118 may have a width measured along the third axis 105 between a first vertical face 138 and a second vertical face 140 thereof. The height of the sill riser 118 may be significantly greater than the width of the sill riser 118 with an aspect ratio of at least 3:1. This aspect ratio of height to width may be at least 4:1 or at least 5:1 in some embodiments. Also, the sill riser 118 may include a terminal end 142 (see FIGS. 2 and 3). The terminal end 142 may be collectively defined by an end or edge of the walls 128 and, thus, the terminal end 142 may be open to the channels 130 defined between the walls 128 of the sill riser 118. In some embodiments, the terminal end 142 may be disposed substantially within a plane that is normal to the axis 101 for joining the sill riser 118 to the first jamb 114 at the first corner joint arrangement 120.

The first jamb 114 may correspond to and/or incorporate features of the sill member 110. For example, the first jamb 114 may be unitary and monolithic and may include a plurality of walls 128 that are interconnected to include channels 130 therein. The first jamb 114 may have a cross-sectional profile taken perpendicular to the second axis 103, and this cross-section may correspond to (e.g., match) the cross-sectional profile of the sill base 117 shown in FIG. FIG. 3. The first jamb 114 may further include an inner face 149 that faces inward along the first axis 101 toward the sash 108 and the glazing unit 106. The first jamb 114 may also include a terminal end 148 (FIGS. 2 and 3), which may be disposed at a non-zero angle relative to the first axis 101. For example, the terminal end 148 may be disposed substantially within a plane that is at approximately a forty-five degree (45°) angle relative to the first axis 101. The terminal end 148 may be disposed at a complimentary angle for joining to the sill base 117 at the first corner joint arrangement 120. Furthermore, an area of the inner face 149 proximate the terminal end 148 may be joined to the sill riser 118 at the first corner joint arrangement 120.

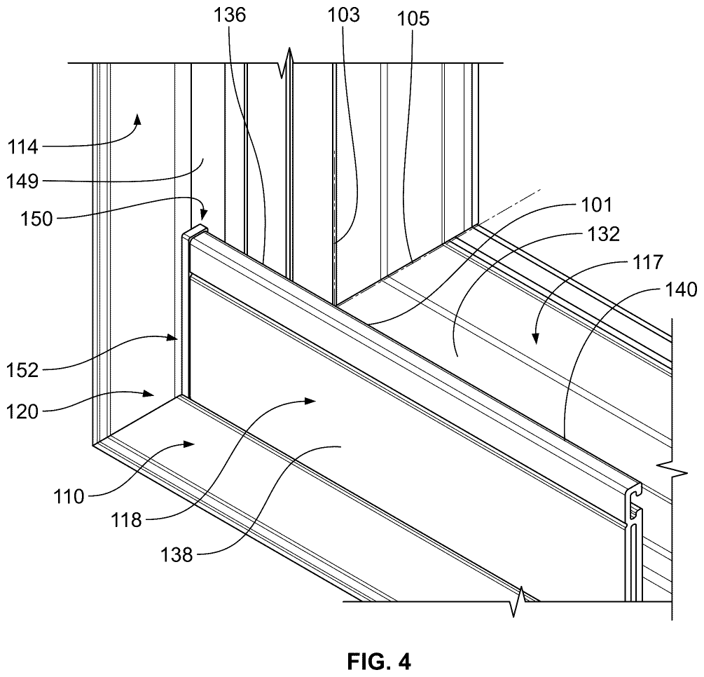

The first corner joint arrangement 120 may further include a weld interface member 150 (i.e., a welding key, a welding insert, implant, gasket, PFUIWK, etc.). The weld interface member 150 may be used for joining the terminal end 142 of the sill riser 118 to the inner face 149 of the first jamb 114. The weld interface member 150 may be used to form a welded joint 152 (i.e., form one or more weldments) for joining the terminal end 148 to the inner face 149 at the first corner joint arrangement 120. As will be discussed, the weld interface member 150 may be formed and tailored as an independent part, separate from the sill member 110 and separate from the first jamb 114. Hence, the weld interface member 150 is shown exploded from the sill member 110 and first jamb 114 in FIGS. 2 and 3. The weld interface member 150 is shown incorporated within the first corner joint arrangement 120 in FIG. 4. Although FIG. 4 includes lines that may appear to delineate the weld interface member 150 from the sill member 110 and first jamb 114, those having ordinary skill in the art will appreciate that such a boundary, in reality, may be less clear. The weldment created may include material from the weld interface member 150 that is blended, fused, combined, integrated with, etc. the material of the sill member 110. Likewise, material from the weld interface member 150 may be blended, fused, combined, or integrated with the material of the first fame 114 in the first corner joint arrangement 120. The weld interface member 150 may also be used to form one or more seals at the first corner joint arrangement 120 as will be discussed.

The weld interface member 150 may be sized, shaped, dimensioned, etc. according to the characteristics of the other members of the joint arrangement 120. Also, the material contents, amounts, concentrations, etc. may be tailored according to the other members of the joint arrangement 120. These features and characteristics may be chosen such that the weld interface member 150 may be used to create the welded joint 152 efficiently, quickly, and to make the welded joint 152 visually appealing.

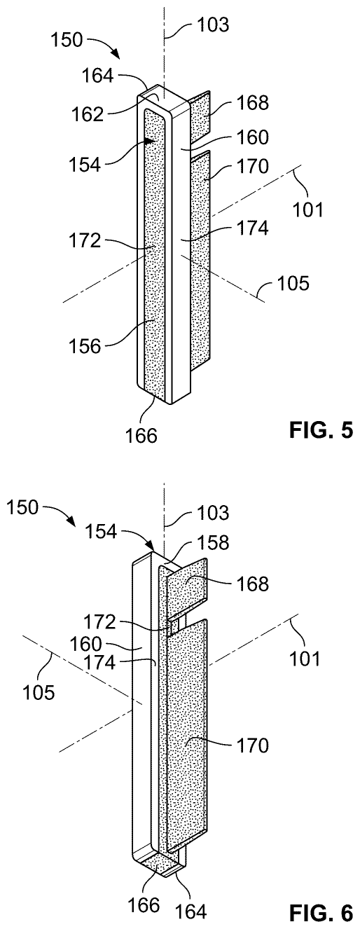

For example, as shown in FIGS. 5 and 6, the weld interface member 150 may include a strip-like gasket portion 154 with a first face 156 and a second face 158, which face in opposite directions along the first axis 101. The gasket portion 154 may also include a rectangular outer edge or border, which includes a first edge 160, a second edge 162, a third edge 164, and a fourth edge 166. The first edge 160 and the third edge 164 may face in opposite directions along the third axis 105, and the second edge 162 and the fourth edge 166 may face in opposite directions along the second axis 103.

The weld interface member 150 may also include at least one projection, such as a first projection 168 and a second projection 170, which may be integrally attached to the gasket portion 154. The first projection 168 and the second projection 170 may project along the first axis 101 from the second face 158 of the gasket portion 154. The first projection 168 and the second projection 170 may be sized, shaped and positioned so as to be received in respective channels 130 of the sill riser 118. Thus, the first and second projections 168, 170 may have a smaller width (measured along the third axis 105) than that of the gasket portion 154, and the first and second projections 168, 170 may be spaced apart at a distance along the second face 158 along the second axis 103.

The weld interface member 150 may be a unitary, one-piece part that includes a plurality of different portions, each portion having different material content. For example, the weld interface member 150 may define a susceptor portion 172 (indicated with stippling in FIGS. 5 and 6) and a cover portion 174. The susceptor portion 172 may include a susceptor material that is susceptible to induction heating, such as a ferrous material, iron oxide, nickel, stainless steel, or other suitable material. The susceptor portion 172 may be a composite material with the susceptor material being embedded within a matrix of interface polymeric material, such as vinyl. The cover portion 174 may be made from a polymeric material, such as vinyl. The cover portion 174 may have a lower concentration, a lower amount by weight or volume, etc. of the susceptor material as compared with the susceptor portion 172. For example, the cover portion 174 may be devoid of the susceptor material (0% susceptor material), and the susceptor material is included instead in the susceptor portion 172 (more than 0% susceptor material). In some embodiments, the same polymeric material (e.g., vinyl) may be included throughout the weld interface member 150, and the susceptor material may be confined or limited to the susceptor portion 172.

The susceptor portion 172 may define a majority of the gasket portion 154, and the cover portion 174 may define the first edge 160, the second edge 162, and the third edge 164. The cover portion 174 may cover over the susceptor portion 172 along the first edge 160, the second edge 162, and the third edge 164. The susceptor portion 172 may be exposed at the fourth edge 166. The susceptor portion 172 may be exposed from the cover portion 174 centrally on the first face 156. The susceptor portion 172 may also be exposed on the second face 158 in the areas surrounding the first and second projections 168, 170. In some embodiments, the first projection 168 and/or the second projection 170 may be devoid of the susceptor material and may be made from the same polymeric material included at the cover portion 174 (e.g., vinyl).

In some embodiments, the weld interface member 150 may be formed via one or more molding processes. For example, in some embodiments, the first projection 168 and the second projection 170 may be molded (e.g., from vinyl), and the susceptor portion 172 may be molded thereon. Then, the cover portion 174 may be over-molded onto the susceptor portion 172.

The material characteristics of the weld interface member 150 may be chosen for providing various advantages. For example, the material may be compatible with the material used to construct the sill member 110 and the first jamb 114. In some embodiments, the weld interface member 150, the sill member 110, and the first jamb 114 may be constructed at least partly from vinyl such that areas may be melted together and re-solidified to form the welded joint 152. Also, the cover portion 174 may substantially match in color and appearance to the sill member 110 and the first jamb 114. The cover portion 174 may also be positioned to cover over and substantially hide the susceptor portion 172 and the susceptor material embedded therein within the welded joint 152.

During manufacture of the first corner joint arrangement 120, a manufacturing system 202 may be utilized. The system 202 may include an induction coil 204. The induction coil 204 may be configured for moving into close proximity to the first corner joint arrangement 120. The system 202 may also include a handling system 206, which may include one or more fixtures, clamps, tables, or other supports configured to hold and support the components of the first corner joint arrangement 120. In some embodiments, the handling system 206 may also include one or more actuators 208 for transport, for assembly, or for other purposes. The handling system 206 may be configured for supporting the first jamb 114 and the sill member 110, for inserting the weld interface member 150 between the first jamb 114 and the sill member 110, and/or for compressing the first jamb 114 and the sill member 110 toward each other along the first axis 101.

The system 202 may additionally include a control system 210, which may be a computerized control system 210, for automating at least part of the assembly process. The control system 210 may include at least one computerized processor 212, which may generate control commands for controlling power to the induction coil 204, for controlling the handling system 206, etc. The processor 212 may receive sensor input from at least one sensor 214. The processor 212 may also retrieve saved data, store new data, or otherwise communicate with a computerized memory device 216. Accordingly, in some embodiments, the sensor 214 may include a thermocouple for detecting temperature at the first corner joint arrangement 120, and the memory device 216 may include a stored program that the processor 212 may run for controlling the power to the induction coil 204. The processor 212 may rely on actual temperature data detected by the sensor for comparison with a target temperature dictated by the program stored in the memory device 216 to thereby control the operation of the induction coil 204. It will be appreciated, however, that the control system 210 may be used for controlling other processes as well.

Thus, during manufacture, the first and second projections 168, 170 may be inserted in the respective channels 130 of the sill riser 118. Then, the sill riser 118 and the first jamb 114 may be held by the handling system 206 and compressed toward each other along the axis 101 with the gasket portion 154 disposed between the terminal end 142 and the inner face 149. Then, the induction coil 204 may be powered such that the susceptor material in the susceptor portion 172 heats up. Heat may continue to rise above the melting temperature of the surrounding materials (e.g., above the melt temperature of the vinyl included in the susceptor portion 172 and the cover portion 174). The susceptor portion 172 may be directly exposed to the inner face 149 and to the terminal end 142 to locally melt the opposing surfaces. Likewise, the susceptor portion 172 may be directly exposed to an upper lip 167 (FIG. 3) of the sill base 117 proximate the terminal end 142 to locally melt these opposing surfaces. The material of the cover portion 174 may also melt due to heat transferred from the heated susceptor material in the susceptor portion 172. In some embodiments, the molten material may run or flow in a predetermined manner to fill in one or more gaps, spaces, cavities, etc. within the first corner joint arrangement 120.

Subsequently, power to the induction coil 204 may be cut, and the molten material may be cooled, cured, or re-solidified while the first corner joint arrangement 120 remains under compression, held by the handling system 206. The material of the weld interface member 150 may melt along with adjacent portions of the sill member 110 and the first jamb 114 and the molten material may re-solidify and fuse together to define the welded joint 152 at the first corner joint arrangement 120. Molten materials may re-solidify to create one or more seals in one or more spaces, gaps, etc. of the joint arrangement 120. For example, one or more channels 130 may be sealed off to limit fluid flow by this process. Also, the material of the cover portion 174 may melt and re-solidify within any gap between the sill member 110 and the first jamb 114 and may advantageously cover over and hide the susceptor material within the re-solidified susceptor portion 172. As a result, the re-solidified cover portion 174 may advantageously provide aesthetically pleasing color matching with the first jamb 114 and the sill member 110 at the corner joint arrangement 120.

Once welded, the corner joint arrangement 120 may be disjoined in a convenient fashion. For example, the joint arrangement 120 may be re-heated via induction heating to re-melt the material for disassembling the joint arrangement 120. This may be useful for repair and replacement purposes.

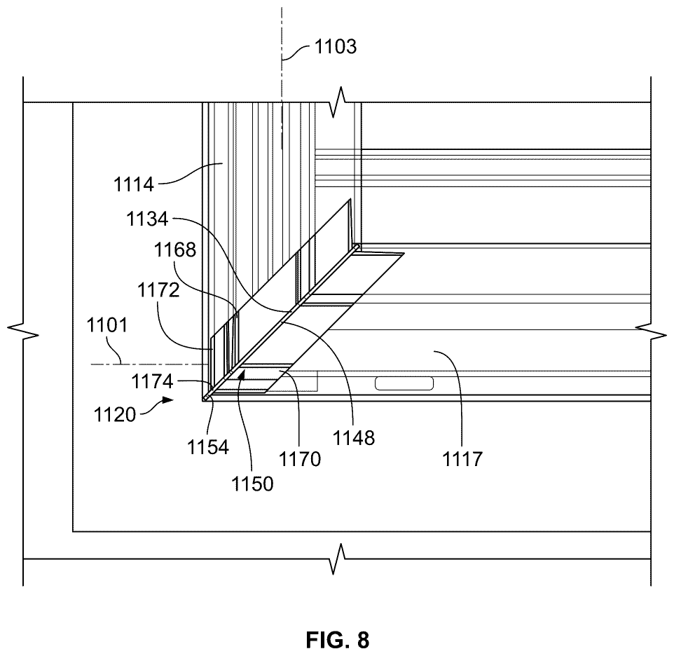

Referring to FIG. 8, the first joint arrangement 1120 is illustrated according to additional features of the present disclosure. The first joint arrangement 1120 of FIG. 8 may be substantially similar to the first corner joint arrangement 120 of FIGS. 2-4 except as noted. Features of the first joint arrangement 1120 that correspond to those of the first corner joint arrangement 120 are indicated with corresponding reference numbers increased by 1000.

As shown, the weld interface member 1150 may be configured for joining the terminal end 1148 of the first jamb 1114 to the terminal end 1134 of the sill base 1117. The gasket portion 1154 may be planar and may be disposed at a non-zero angle (e.g., a 45 degree angle) relative to the first axis 1101 and the second axis 1103. The weld interface member 1150 may also include at least one first projection 1168 and at least one second projection 1170. The first projection 1168 may project from the gasket portion 1154 along the second axis 1103 to be received within the terminal end 1148 of the first jamb 1114. The second projection 1170 may project from the gasket portion 1154 along the first axis 1101 to be received within the terminal end 1134 of the sill base 1117.

The weld interface member 1150 may be sized, shaped, dimensioned, etc. according to the characteristics of the other members of the joint arrangement 1120. Also, the material contents, the amount of material, the concentration of different materials, etc. may be different across different portions of the weld interface member 1150. There may be areas or zones of the weld interface member 1150 that define the susceptor portion 1172 and different areas or zones that define the cover portion 1174 as discussed above. The susceptor portion 1172 may be included and exposed on the gasket portion 1154 and/or the first projection 1168 in areas that abut against the terminal end 1148 during the induction heating process. The susceptor portion 1172 may be included and exposed on the gasket portion 1154 and/or the first projection 1168 in areas that abut against the terminal end 1134 during the induction heating process. The cover portion 1174 may be included and exposed on the peripheral outer edge of the gasket portion 1154 and exposed between the terminal ends 1134, 1148 when viewed from an exterior vantage point of the joint arrangement 1120 as shown in FIG. 8.

During manufacture, the manufacturing system 202 may be utilized to form the induction welded first joint arrangement 1120. The weld interface member 1150 may melt due to the induction welding process along with adjacent portions of the terminal end 1148 and the terminal end 1134 of the sill base 1117. Then, the molten material may be cooled, cured, and re-solidified to form the welded first joint arrangement 1120. This process may include melting the material of the cover portion 1174 due to the induction heating of the susceptor portion 1172 and subsequent cooling, curing, and re-solidifying the material of the cover portion 1174 to cover over the re-solidified susceptor portion 1172 from an exterior vantage point when viewing the first joint arrangement 1120.

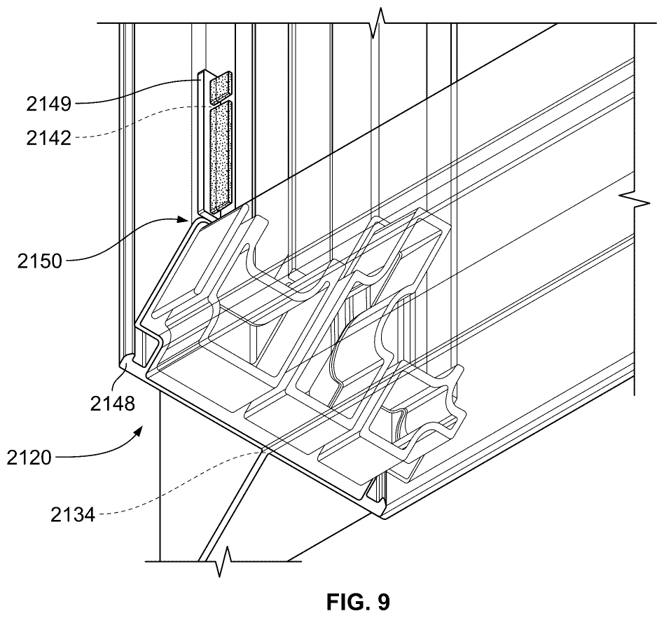

Referring to FIG. 9, the first joint arrangement 2120 is illustrated according to additional features of the present disclosure. The first joint arrangement 2120 of FIG. 9 may combine features disclosed in relation to the first corner joint arrangement 120 of FIGS. 2-4 and the first joint arrangement 1120 of FIG. 8. Features of the first joint arrangement 2120 that correspond to those of the first corner joint arrangement 120 are indicated with corresponding reference numbers increased by 2000. Features of the first joint arrangement 2120 that correspond to those of the first joint arrangement 1120 are indicated with corresponding reference numbers increased by 1000.

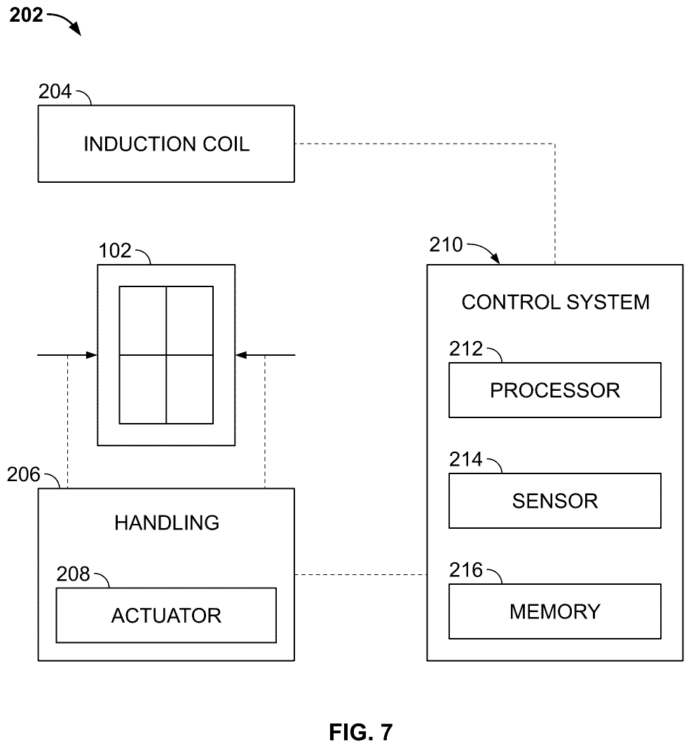

In some embodiments, the weld interface member 2150 may be configured for joining the terminal end 2148 of the first jamb 2114 to the terminal end 2134 of the sill base 2117 (shown in phantom). In addition, the weld interface member 2150 may be configured for joining the terminal end 2142 of the sill riser 2118 to the inner face 2149 of the first jamb 2114. Thus, the weld interface member 2150 may include a combination of the features discussed in relation to FIGS. 2-8. In some embodiments, the weld interface member 2150 may be unitary. In other embodiments, the weld interface member 2150 may be separate, independent members, wherein one is used for joining the terminal end 2148 to the terminal end 2134 and another is used in a separate induction heating process for joining the terminal end 2142 to the inner face 2149.

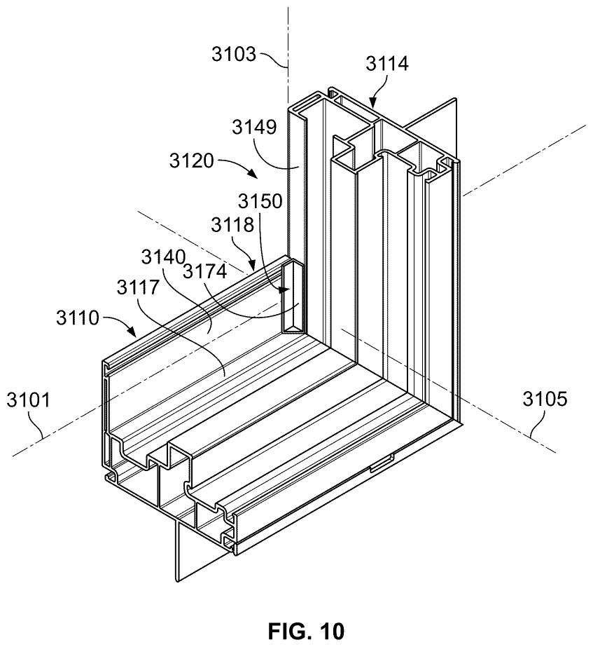

Referring now to FIG. 10, the first joint arrangement 3120 is illustrated according to additional embodiments of the present disclosure. The first joint arrangement 3120 of FIG. 10 may be substantially similar to the first corner joint arrangement 120 of FIGS. 2-4 except as noted. Features of the first joint arrangement 3120 that correspond to those of the first corner joint arrangement 120 are indicated with corresponding reference numbers increased by 3000.

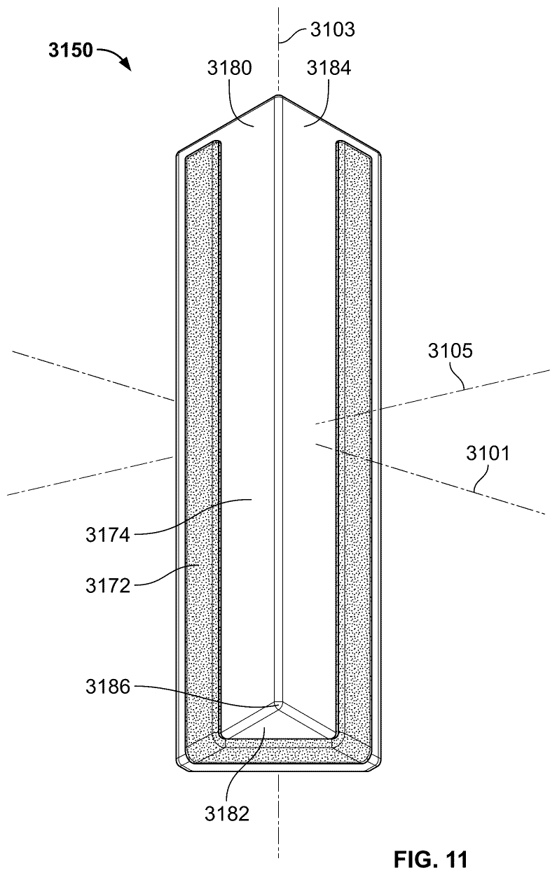

The first joint arrangement 3120 may be configured and tailored for joining the sill member 3110 to the first jamb 3114 and may include the weld interface member 3150 shown in FIG. 11. The weld interface member 3150 may include a plurality of substantially planar walls, including a first wall 3180, a second wall 3182, and a third wall 3184. The walls 3180, 3182, 3184 may be orthogonal to each other and may be joined along respective edges that meet at a corner point 3186.

As represented in FIG. 11, the weld interface member 3150 may include the susceptor portion 3172 and the cover portion 3174. The cover portion 3174 may define a majority of the walls 3180, 3182, 3184. The susceptor portion 3172 may included on a localized portion of one face of the walls 3180, 3182, 3184 (i.e., the face to be directed toward the fenestration frame 3104). The susceptor portion 3172 may be a continuous band extending longitudinally from the first wall 3180, along the second wall 3182, to the third wall 3184.

To form the induction welded first joint arrangement 3120, the first wall 3180 may be layered over the inner face 3149, the second wall 3182 may be layered over the sill base 3117, and the third wall 3184 may be layered over the second vertical face 3140 of the sill riser 3118 (FIG. 10). Also, the corner point 3186 may be received between the vertical and horizonal surfaces of the first joint arrangement 3120. As such, the susceptor portion 3172 may be layered and abutted directly over the sill member 3110 and the first jamb 3114. The joint arrangement 3120 may be compressed together. Then, the material of the susceptor portion 3172 may be heated by induction heating to melt the material of the cover portion 3174 and the adjacent areas of the sill member 3110 and first jamb 3114. Subsequently, the molten material may be cooled, cured, and re-solidified, resulting in the welded first joint arrangement 3120. It will be appreciated that the material of cover portion 3174 may re-solidify so as to cover over and hide the material of the re-solidified susceptor portion 3172 from the perspective of FIG. 10. Advantageously, the joint arrangement 3120 may be constructed efficiently and may be robust and aesthetically pleasing.

It is intended that subject matter disclosed in particular portions herein can be combined with the subject matter of one or more of other portions herein as long as such combinations are not mutually exclusive or inoperable. In addition, many variations, enhancements and modifications are possible.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It is understood that various changes may be made in the function and arrangement of elements described in an exemplary embodiment without departing from the scope of the disclosure as set forth in the appended claims.

What is claimed is:

1. A method of manufacturing a fenestration unit comprising:
providing a first member of the fenestration unit, the first member formed at least partly from a polymeric material;
providing a second member of the fenestration unit, the second member formed at least partly from a polymeric material;
providing a weld interface member having a susceptor portion and a cover portion, at least the susceptor portion including a susceptor material that is susceptible to induction heating, the cover portion including a cover material;
positioning the weld interface member against the first member and the second member at a joint arrangement;
heating, by induction heating, the susceptor material to melt the susceptor portion and the cover portion; and
re-solidifying the susceptor portion and the cover portion to attach the first member and the second member, including covering the susceptor material at the joint arrangement with a resolidified portion of the cover material.

2. The method of claim 1, wherein at least one of the first member and the second member is a lineal member extending along a longitudinal axis, and wherein the joint arrangement includes a terminal end of the lineal member.

3. The method of claim 2, wherein the first member comprises a sill riser of the fenestration unit, and the second member comprises a jamb of the fenestration unit, the joint arrangement including the terminal end of the sill riser and the jamb.

4. The method of claim 2, wherein the first member is a first lineal member with a first terminal end, the second member is a second lineal member with a second terminal end, and the joint arrangement includes the first terminal end and the second terminal end.

5. The method of claim 2, wherein the first member includes a side surface facing away from the axis, and wherein positioning the weld interface member includes layering the weld interface member against the side surface and against the second member.

6. The method of claim 1, wherein at least one of the first member and the second member includes a channel, and further comprising inserting the weld interface member into the channel.

7. The method of claim 1, wherein at least one of the first member and the second member includes a channel, and wherein re-solidifying the susceptor portion and the cover portion includes defining a seal limiting fluid movement with respect to the cavity.

8. The method of claim 1, further comprising forming the weld interface member, including forming the cover portion that covers over the susceptor portion.

9. The method of claim 1, further comprising re-heating, by induction heating, the susceptor material to disjoin the first member and the second member.

10. A weld interface member for joining a first member and a second member of a fenestration unit at a joint arrangement, the first member and the second member formed at least partly from a polymeric material, the weld interface member comprising:
a susceptor portion;
a cover portion;
at least the susceptor portion including a susceptor material that is susceptible to induction heating, the cover portion including a cover material; and
the susceptor material being susceptible to induction heating for melting the susceptor portion and the cover portion, the cover material configured to re-solidify at a resolidified portion that covers the susceptor material at the joint arrangement.

11. The weld interface member of claim 10, wherein the susceptor portion includes the susceptor material embedded in an interface polymeric material, and wherein the cover portion includes the interface polymeric material.

12. The weld interface member of claim 11, wherein the interface polymeric material is vinyl.

13. The weld interface member of claim 10, wherein the cover portion includes a substantially planar surface configured to overlap the first member.

14. The weld interface member of claim 13, wherein the weld interface member includes a plurality of substantially planar surface that are orthogonal to each other.

15. The weld interface member of claim 14, wherein the susceptor portion comprises a band extending continuously over the plurality of substantially planar surfaces.

16. The weld interface member of claim 10, wherein the cover portion is included at a peripheral edge of the weld interface member.

17. The weld interface member of claim 10, further comprising a gasket portion and a projection that projects from the gasket portion, the gasket portion configured to be received between the first member and the second member.

18. A manufacturing system for manufacturing a fenestration unit comprising:
an induction welding device;
a handling system for handling a first member of the fenestration unit, a second member of the fenestration unit, and a weld interface member, the first member formed at least partly from a polymeric material, the second member formed at least partly from a polymeric material, and the weld interface member having a susceptor portion and a cover portion, at least the susceptor portion including a susceptor material that is susceptible to induction heating, the cover portion including a cover material, the welding interface member positioned against the first member and the second member at a joint arrangement;
the induction welding device configured to induction heat the susceptor material to melt the susceptor portion and the cover portion before the susceptor portion and cover portion are re-solidified to attach the first member and the second member, wherein the susceptor material is covered at the joint arrangement with a resolidified portion of the cover material.

19. The manufacturing system of claim 18, further comprising a control system with a processor for controlling the induction welding device.

20. The manufacturing system of claim 18, wherein the handling system is configured to compress the first member, the second member, and the weld interface member.
